(19) United States
(12) Patent Application Publication
(10) Pub. No.: US 2008/0300924 A1
(43) Pub. Date: Dec. 4, 2008

(54) METHOD AND SYSTEM FOR PROJECTING CATASTROPHE EXPOSURE

(75) Inventors: John Savage, Fair Haven, NJ (US); David Lee, Brooklyn, NY (US); Lucy Lyulkin, New Milford, NJ (US); Charles R. Schader, New York, NY (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 12/130,497

(22) Filed: May 30, 2008

Related U.S. Application Data
(60) Provisional application No. 60/941,513, filed on Jun. 1, 2007.

(51) Int. Cl. G06Q 10/00; G06Q 40/00

(52) U.S. Cl. 705/4; 705/7

(57) ABSTRACT

A web-based application for an insurance carrier that combines national account information and detailed insurance policy information with catastrophe modeling technology. As an event occurs, the modeling technology determines a projected damage area that the event will cause. The insurance carrier can cross-reference that information with its account and policy information. In a short time, the insurance carrier can generate the following catastrophe exposure data: (1) summary reports indicating the projected number of damaged locations for each account; (2) maps and graphs of each account's affected locations that provide a visual image of the epicenter and the concentration of the losses; and (3) tables with detailed property location information. After receiving this data, the insurance carrier can secure the services of independent adjusters and assign other resources according to the scope and magnitude of the projected loss.

### CROSS-REFERENCE TO RELATED PATENT APPLICATION

This application claims the benefit of U.S. Provisional Patent Application No. 60/941,513, filed Jun. 1, 2007, and entitled “Method and System For Projecting Catastrophe Exposure,” which is incorporated in its entirety herein by this reference.

### FIELD OF THE INVENTION

The present invention relates generally to a method and system for projecting the financial exposure for an insurance company and reporting the same.

### BACKGROUND OF THE INVENTION

U.S. Pat. No. 6,049,773 and U.S. Patent Application Publication No. US 2007/0118291 are cited as background art. In response to a catastrophe, such as a hurricane, an insurance company commonly hires outside independent adjusters to help process claims from its policy holder affected by the catastrophe. These outside independent adjusters can assess the insured's damage caused by the catastrophe and allow the insurer liability more quickly and accurately. However, there is a finite availability of outside independent adjusters available in any given geographic area, with varying levels of ability existing in the pool of available adjusters. Without the proper number of competent adjusters, an insurance company can be hampered in its claim-processing abilities to assess their liabilities and perform their business adequately.

Therefore, there is a need for methods and systems for quickly determining a net loss suffered by an insurance company's insureds as a result of a catastrophe. There is also a need in the industry for an insurance carrier to promptly and accurately predict the amount of adjusters that it will need to respond to a catastrophe.

### BRIEF SUMMARY OF THE INVENTION

Embodiments of methods and systems for projecting the financial exposure of an insurance company from a catastrophe are disclosed, which can create management reports that integrate an independent adjuster account database, an insurance policy database, and a catastrophe model. The catastrophe exposure projection can allow the user to identify potential claims from a group of policyholders located in a geographical region that is projected to be affected by the catastrophe, based on a catastrophe model, for example. The method and system for projecting catastrophe exposure can allow an insurance carrier to project, organize, and deploy rapidly the necessary resources in the case of a loss event. A loss event can be, but is not limited to, a catastrophe such as a natural disaster, hurricane, or accident. As a loss event occurs, the modeling technology can model the loss event by comparing the loss event with a database of similar historic events and matching it with the historic event that most closely corresponds to the loss event presently occurring. Based on the modeled event information, the system can generate a projected damage area, which can be a geographic area within which damage from the event is likely to occur as determined by the modeled event. The system can identify the insurance company's policy holders located within the projected damage area by querying the insurance policy database. Based on the number of policy holders located within the projected damage area, the system can forecast the number of independent adjusters that the insurance company prefers to use to help process claims from the insured located within the projected damage area. The system can identify the number of independent adjustors by querying the independent adjustor account database, using one or more predetermined factors such as geographic location, competency, pricing, etc.

In a short time, the insurance carrier can forward the following catastrophe exposure data to each outside independent adjuster: (1) a summary report indicating the projected number of damaged locations for each of your accounts; (2) maps and graphs of each accounts' affected locations that provide a visual image of the epicenter and the concentration of the losses; and (3) property detail information contained, for example, in tables with detailed property location information that will further assist efforts to manage the inventory of damaged properties and assign resources. After receiving these reports, the insurance carrier can initiate discussions with the independent adjuster management teams. Furthermore, insurance carriers can pursue opportunities to handle unassigned commercial catastrophe claims.

In one embodiment, a web-based catastrophic exposure reporting system can provide the management teams of an insurance company with an initial projection of the scope and magnitude of a catastrophe, such as a hurricane, by establishing a projected damage area and an identification of the insurance company's insured within the projected damage area. A management report can be generated that combines account information of the insureds, detailed policy information, and a projected damage area based on a catastrophe modeling system. The insurance company can rapidly project, organize, and deploy the necessary resources in the event of a hurricane, such as deploying a corps of adjusters to the projected damage area based on the information generated from the catastrophe modeling system.

In one aspect, approximately twenty-four hours prior to landfall, in the case of a hurricane, for example, the catastrophe modeling system can identify a modeled event from a set of modeled events that is determined to have the highest likelihood of corresponding to the behavior of the actual storm. With that information in hand, the insurance company can generate exposure information, such as, summary reports that project the number of damaged locations for each account; maps and graphs of each account's projected affected locations that provide a visual image of the epicenter and the concentration of projected losses; and tables with detailed property location information that can further assist the insurance company's efforts to manage the inventory of projected damaged properties and to assign resources.

### BRIEF DESCRIPTION OF THE SEVERAL VIEWS OF THE DRAWINGS

FIG. 1 is a flow chart illustrating an embodiment of a catastrophe exposure reporting method.

FIG. 2 is a schematic illustrating an embodiment of a web-based catastrophe exposure reporting system.

FIG. 3 is a Login webpage suitable for use with the system of FIG. 2.

FIG. 4 is an Event Preview and Maintenance webpage suitable for use with the system of FIG. 2.

FIG. 5 is a catastrophe Maintenance Scheduler webpage suitable for use with the system of FIG. 2.

FIG. 6 is an Incorrect Password Supplied to Maintenance Scheduler webpage of the web application embodiment implementing the catastrophe exposure reporting method.

FIG. 7 is a Display of Available Databases for Update webpage of the web application embodiment implementing the catastrophe exposure reporting method.

FIG. 8 is a Display of Selected Database for Update webpage displayed after selecting a database listed in the Display of Available Databases for Update webpage of FIG. 7.

FIG. 9 is an Exposure Map generated by the system of FIG. 2.

FIG. 10 is a Summary Report generated by the system of FIG. 2.

FIG. 11 is a Detail List Report generated by the system of FIG. 2.

FIG. 12 is a Query Tool webpage suitable for use with the system of FIG. 2.

FIG. 13 is a Summary Report listing the number of locations for each insured located within a projected damage area by county.

FIG. 14 is a Detail Report listing information for each location of an insured within the projected damage area.

FIG. 15 is a plot of the locations of all of an insurance company's policyholders within the projected damage area.

FIG. 16 is a plot of the locations of a single policyholder of an insurance company within the projected damage area.

### DETAILED DESCRIPTION OF THE INVENTION

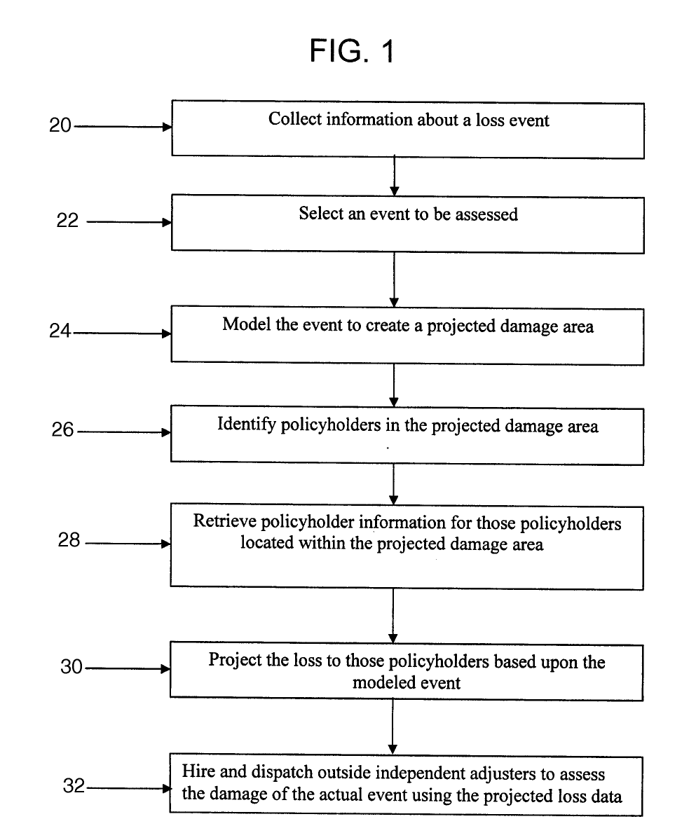

The present invention is a method for reporting projected catastrophe exposure with sufficient lead-time, for example, to help an insurance carrier hire and dispatch a sufficient number of outside independent adjusters in the event of a loss event. FIG. 1 is a flow chart illustrating steps of an embodiment of a method for report projected catastrophe exposure. In a first step 20, the insurance carrier collects information of the loss event. The loss event can be a natural disaster such as a flood, hurricane, or earthquake, or can be a man-made event such as a car accident or fire. In a second step 22, the insurance carrier selects the event to assess the loss exposure it will cause. In a third step 24 of the method, the selected event is modeled using any suitable catastrophe modeling system to create a projected damage area.

The modeling step 24 is preferably performed using a computing environment. Catastrophe modeling can use computer technology to help insurers, reinsurers and risk managers assess the potential losses caused by the selected loss event. In some embodiments, catastrophe modeling combine historical disaster information with current demographic, building (age, type and usage, e.g.), scientific and financial data to determine the potential impact of the selected event for a specified geographic area. The catastrophe modeling system can use these databases of information to simulate the physical characteristics of the selected event and project its effects on both residential and commercial property. The catastrophe modeling system commercially offered by Risk Management Solutions (RMS) under the name Risk Link, version 6.0, can be used to perform the modeling step 24. In other embodiments, any other suitable catastrophe modeling system can be used such as those commercially available from Applied Insurance Research (AIR) Worldwide and EQECAT (also known as EQE) as well as other systems available from RMS.

In a fourth step 26, the insurance carrier identifies its policyholders in the projected damage area. In a fifth step 28, policyholder information is retrieved for those policyholders located within the projected damage area. In a sixth step 30, the loss to those policyholders in the projected damage area is projected based upon the modeled event. This projected loss data can be stored into a new database. The insurance carrier can access the projected loss data to present the information in exposure maps, spreadsheets, summary reports, detailed reports, and custom queries, for example. In a seventh step 32, the insurance company can hire and dispatch outside independent adjusters, based at least in part upon the projected loss data, to assess the damage of the actual event.

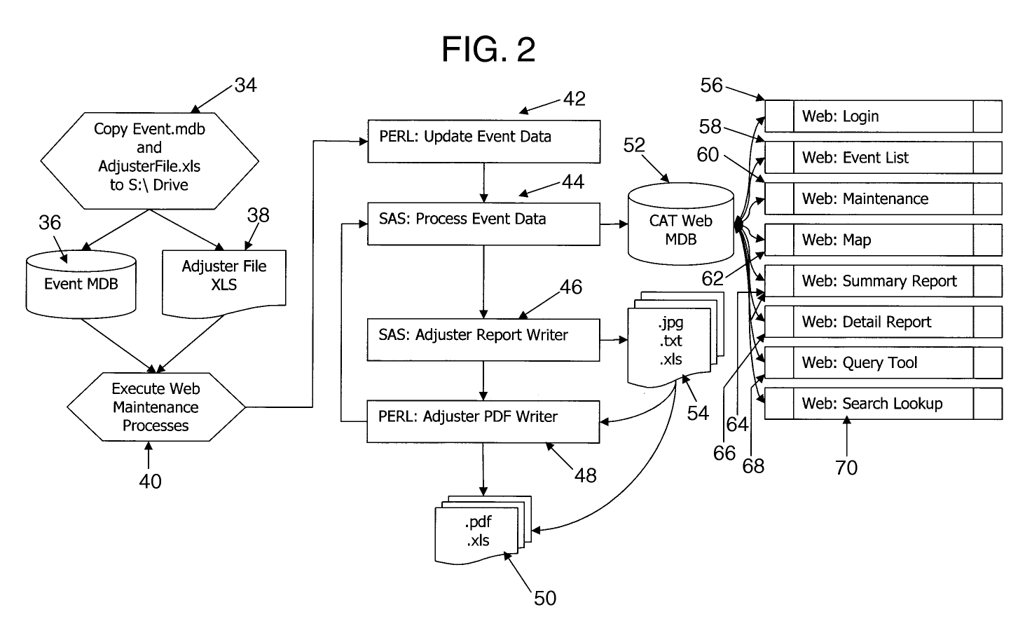

Embodiment of the present invention can be implemented using a web application. FIG. 2 displays a flow chart of an embodiment of a method for projecting catastrophe exposure using a web application. In a first step 34, the application method copies the Event.mdb and AdjusterFile.xls files to a network drive. The Event.mdb file 36 is a Microsoft Access file that holds the Event database of the application. The AdjustcrFile.xls 38 is a Microsoft Excel file that contains the outside independent adjuster account information. In the next step of the method, the application initiates Execute Web Maintenance Processes 40. Maintenance can mean updating and processing the modeled event with the current policyholder information of the insurance carrier and the account information of the outside independent adjusters. The next step 42 can update the modeled event data using PERL script. The next step 44 can process the data using SAS software tools. After processing the data, the method not only stores the resulting data in the Catastrophe Web Database 52 but also sends the data to the Adjuster Report Writer 46. Next, SAS software tools performs the Adjuster Report Writer function 48 to produce reports for outside independent adjusters in JPEG, text, and Excel formats 54. The Adjuster PDF Writer 48 converts the JPEG, text, and Excel files to produce PDF and Excel files for outside independent adjusters using PERL script. The user can access the Catastrophe Web Database 52 from the web user interface. Although certain software tools (e.g. PERL, SAS Microsoft Access, Excel, Web user interface etc.) are illustrated for performing certain functions in this embodiment of the invention, the present invention is not limited to these software tools in particular in implementing these functions. In other embodiments, other suitable software tools can be used.

The web user interface can be used to query the Catastrophe Web Database. Upon starting the user interface portion, the user can be asked to log into the application 56. An Event List can be generated for the user 58. The user can perform maintenance on the selected event 60. Maintenance can occur according to a planned schedule or on an as-needed basis, for example. An Exposure Map 62 can be generated for the user. When queried by the user, the system can provide a Summary Report 64. When queried by the user, the system can provide a Detail report 66. The system can include a Query Tool 68 to the user. Finally, the user can search the event data for particular subject matter 70. Although FIG. 2 depicts a particular embodiment of a user interface as implemented using web technology, the present invention is not limited to a web-based user interface.

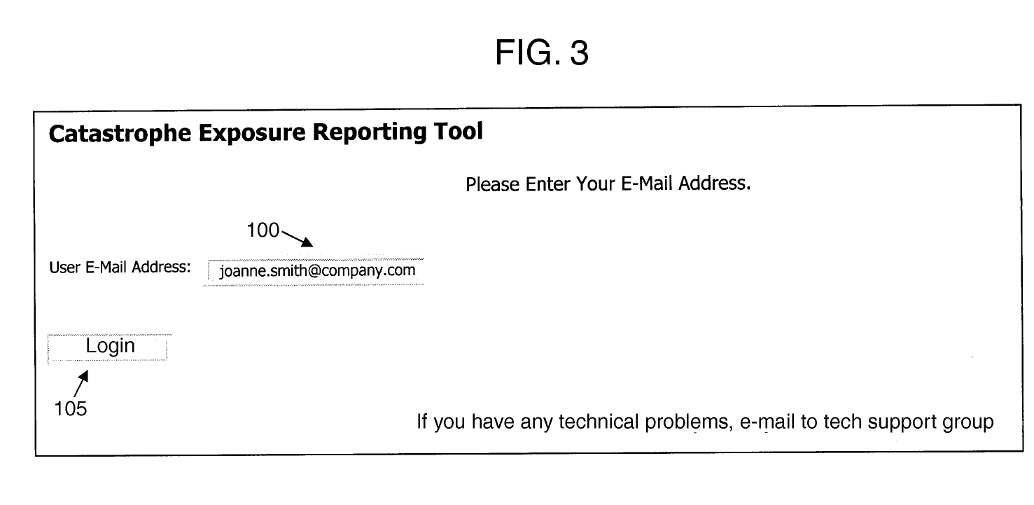

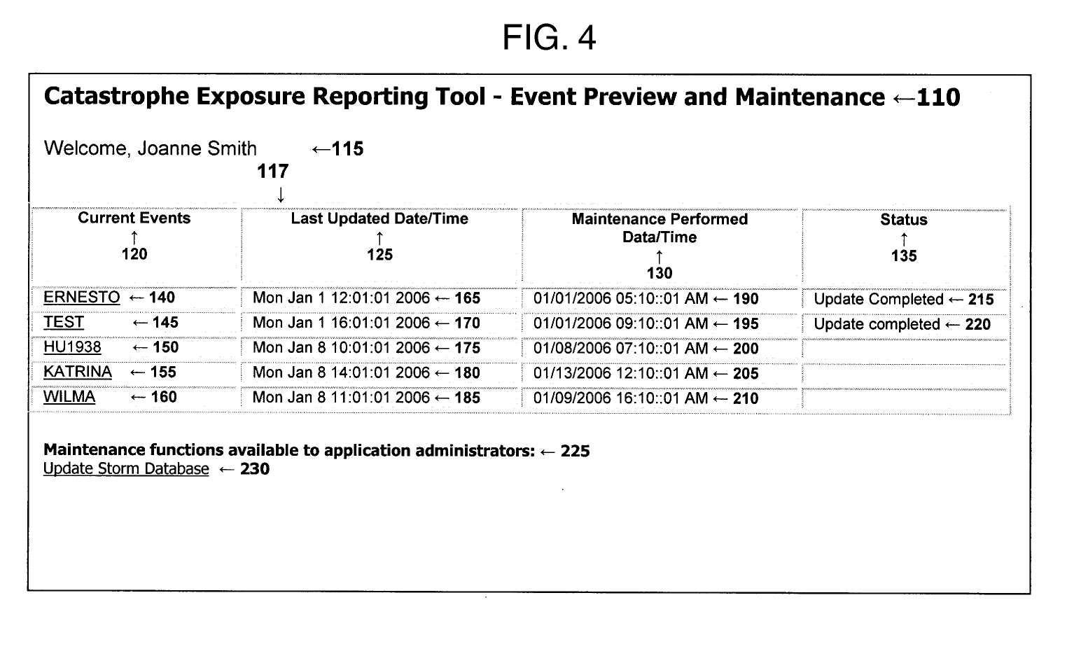

FIG. 3 is a Login Page of a web application implementing a method for projecting catastrophe exposure. In this embodiment, the user accesses the web application by entering her email address. Her email address can be compared to a list of users that have permission to access the application. If her email address matches the list of users, then she will be granted access to the application. (See FIG. 4). Otherwise, she will be denied access. After entering her email address in the dialog box 100, the user will “click” the “Login” push button 105 to initiate the application to compare the user-entered email address with the list of users granted permission to access the application.

In this embodiment, an email address is used to gain access to the application. However, the present invention is not limited to only this embodiment. There can be other methods of gaining access to the application such as entering a user name and password.

FIG. 4 is the Event Preview and Maintenance Page of the web application embodiment implementing the present invention. The title of the page is across the top of the page 110. The User Name is underneath the title 115. Under the User Name is a table of data, four columns wide 117 that list the current events available to the user. The first column lists the name of each event 120. The second column lists the last time the event was updated 125 with the insurance carrier's policy information and outside adjuster account information. The third column lists the last time maintenance was performed on the Event 130. Finally, the fourth column lists the status of the event 135.

In this embodiment, the second row of the table in FIG. 4 displays information for the ERNESTO Event 140. The second row of the second column 165 shows the last time the ERNESTO Event 140 was updated. The second row of the third column 190 displays the last time maintenance was performed on the ERNESTO Event 140. Finally, the second row of the fourth column 215 displays the status of the ERNESTO Event 140. The third row provides information for the TEST Event 145. Similar to the ERNESTO Event, the third row of the second column 170 shows the last time the TEST Event 145 was updated. The third row of the third column 195 displays the last time maintenance was performed on the TEST Event 145. Finally, the third row of the fourth column 220 displays the status of the TEST Event 145. The fourth row displays information for the HU1938 Event 150. Similar to the TEST Event, fourth row of the second column 175 shows the last time the HU1938 Event 150 was updated. The fourth row of the third column 200 displays the last time maintenance was performed on the HU1938 Event 150. The fifth row of the first column displays information for the KATRINA Event 155. Similar to the HU1938 Event, the fifth row of the second column 180 shows the last time the KATRINA Event 155 was updated. The fifth row of the third column 205 displays the last time maintenance was performed on the KATRINA Event 155. The sixth row of the first column displays information for the WILMA Event 160. Similar to the KATRINA Event, the sixth row of the second column 185 shows the last time the KATRINA Event 160 was updated. The sixth row of the third column 210 displays the last time maintenance was performed on the KATRINA Event 160.

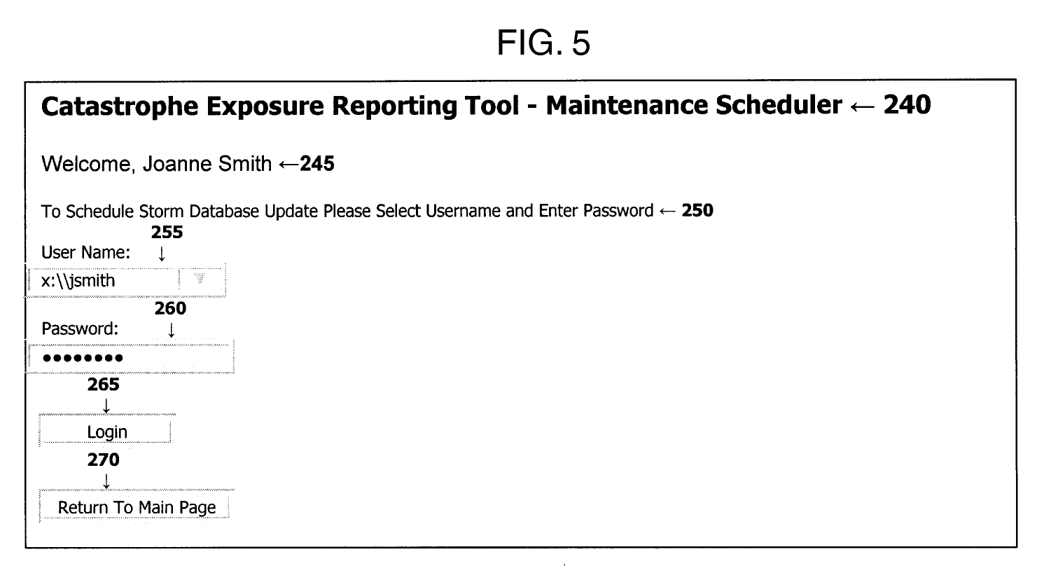

Also in FIG. 4, the bottom of the page lists the maintenance functions available to application administrators 225. In this embodiment, the only maintenance function available to the user is “Update Storm Database” 230. The “Update Storm Database” function can be made available only to users with proper administrative permissions. When the “Update Storm Database” function is selected, the Catastrophe Maintenance Scheduler page of the embodiment can be displayed (See FIG. 5).

FIG. 5 is the Catastrophe Maintenance Scheduler Page of the web application embodiment implementing the present invention. The text across the top of the page 240 displays the title. The text below the title 245 displays the user name. The text below the user name 250 instructs the user to enter her User Name and Password to gain access to scheduling maintenance of an Event. In this embodiment, drop down menu 255 allows the user to choose her User Name. The dialog box 260 allows the user to enter her password. The push button 265 below the password dialog box 260 allows the user to log into the Maintenance Scheduler. Finally, the push button at the bottom of the page 270 allows the user to return to the main page of the application.

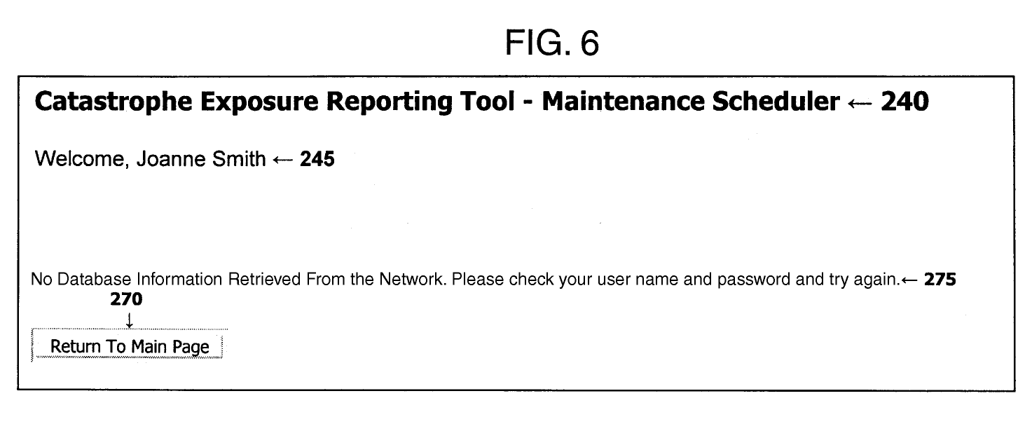

FIG. 6 is the Incorrect Password Supplied to the Maintenance Scheduler Page of the web application. However, when the user supplies and incorrect password text in the middle of the page 275 provides a message to the user indicating that no Database was retrieved and that the user should check her User Name and Password.

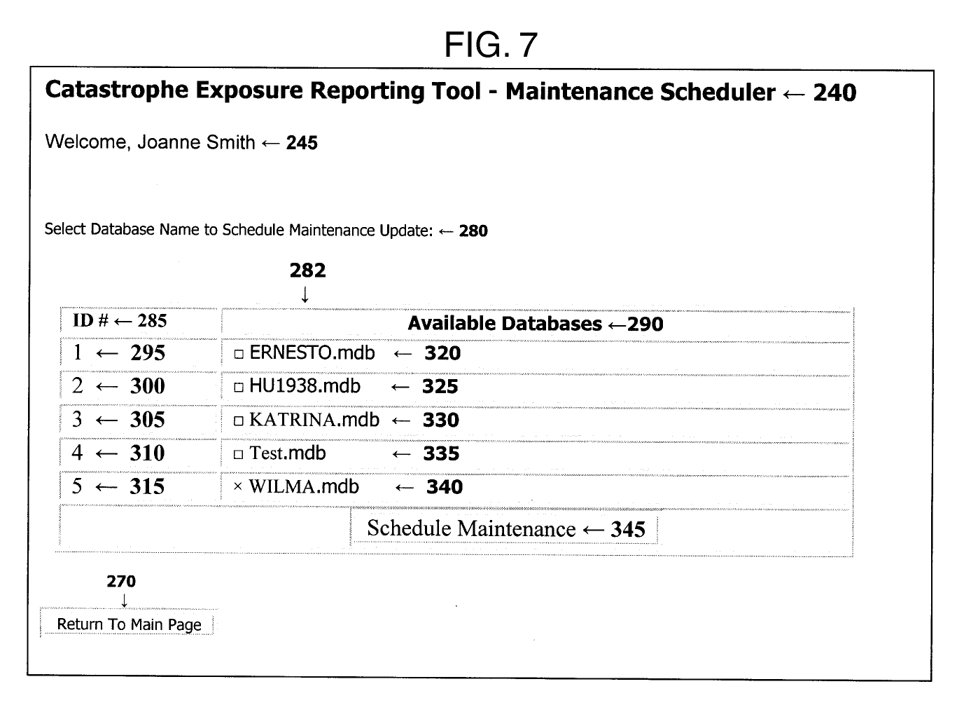

FIG. 7 is the Display of Available Databases for Update Page of the web application embodiment. This page appears after the user has successfully logged into the Maintenance Scheduler. The text in the middle of the page 280 instructs the user to select a database from the table 282 to schedule for maintenance update. The table 282 comprises of two columns containing the identification numbers (295, 300, 305, 310, and 315) of the databases 285 and a list of available databases to the user 290. In this embodiment, the list of available databases includes ERNESTO.mdb 320, HU1938.mdb 325, KATRINA.mdb 330, Tcst.mdb 335, and WILMA.mdb 340. In this embodiment, WILMA.mdb 340 has been selected to be scheduled for maintenance. The user can schedule WILMA.mdb 340 for maintenance by pushing the push button labeled Schedule Maintenance 345.

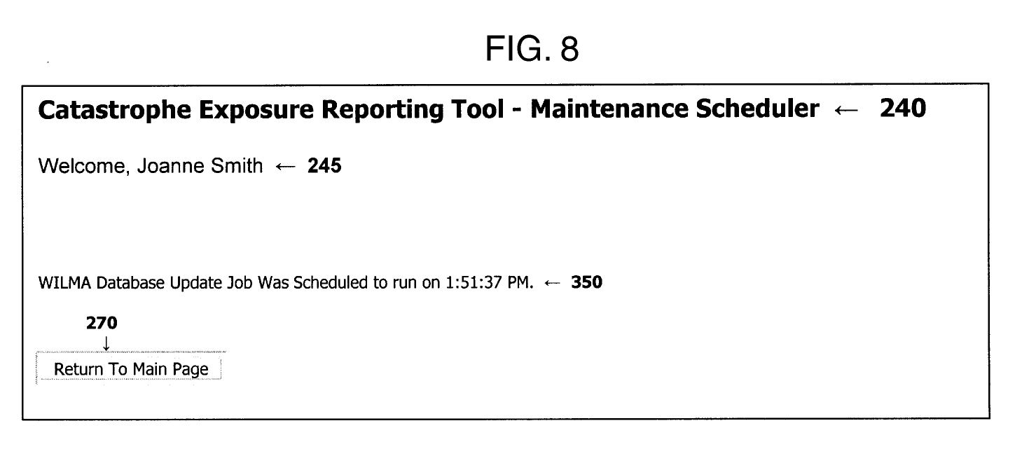

FIG. 8 is the Display of Selected Database for Update Page of a web application embodiment. This page of the embodiment can be shown after the user selected the database to update and “clicked” on the Schedule Maintenance button of the web page pictured in FIG. 7 to initiate update procedures. The text in the middle of the page 350 provides information to user concerning the database selected to be updated and when the update will occur. In this embodiment, the user is informed that the WILMA Database was scheduled to be updated at 1:51 p.m. If no database is selected for maintenance on the web page pictured in FIG. 7, the Login Page (FIG. 3) can be displayed to the user. In addition, the following message can be displayed to the user: “Database for Maintenance was not selected. Please reenter information and try again.”

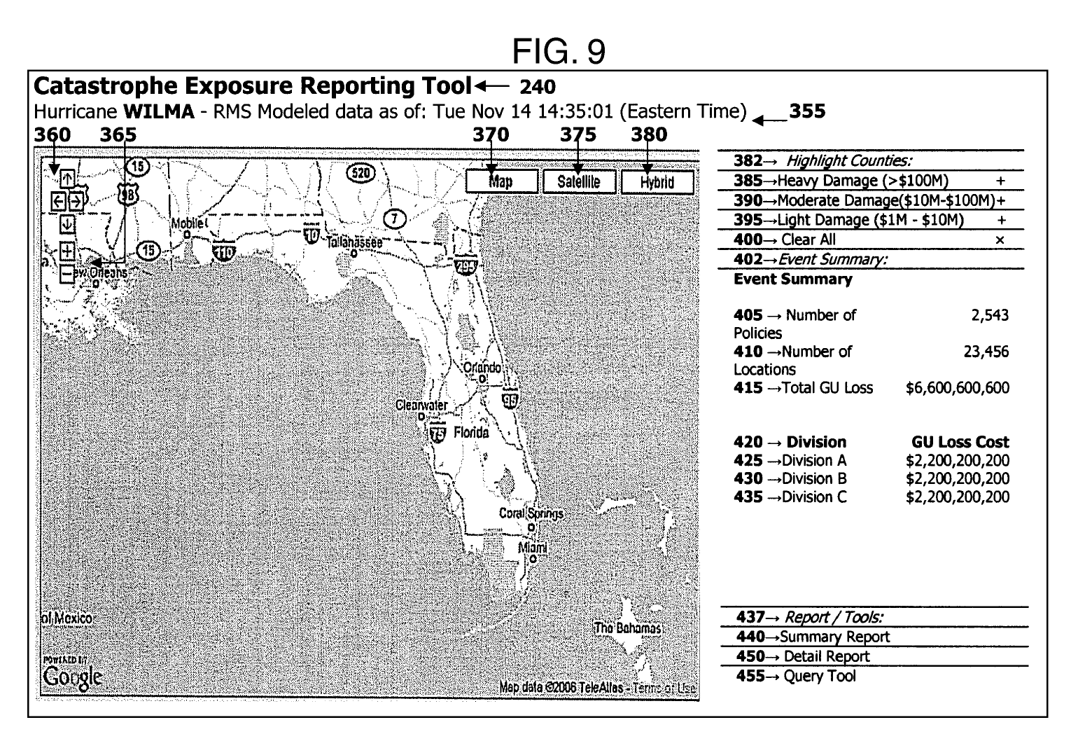

Referring back to FIG. 4, if the user selects any of the Events (140, 145, 150, 155, 160) the present embodiment will display an Exposure Map to the user (See FIG. 9). In FIG. 9, the embodiment displays an Exposure Map of the WILMA Event that the user selected from the List of Current Events pictured in FIG. 4. The text underneath the title 355 states the Event Name displayed on the Exposure Map. Arrow buttons 360 allow the user to scroll in any direction across the Exposure Map. The “+” and “−” buttons 365 allow the user to zoom in or out of the Exposure Map. The Event Summary is shown in the frames to the right of the map. The first frame 382 allows the user to highlight counties that have different ranges of damage. In this embodiment, the user can select the green “+” symbol in the first row of the first frame 385 to indicate counties with Heavy Damage (greater than $100 million) in red. Similarly, if the user wants to highlight counties with Moderate Damage (between $10 million and $100 million) then she selects the green “+” symbol in second row of the first frame 390. The exposure map can highlight moderately damage counties in blue. Finally, if the user wants to highlight counties with only Light Damage (between $1 million to $10 million) then she selects the green “+” symbol in third row of the first frame 395. The exposure map can highlight lightly damaged counties in green. The user can then clear any colored highlighting of any Damage range by selecting the red “x” symbol in fourth row of the first frame 400. County Summary information can be dynamically refreshed after the user “clicks” on county in the map.

FIG. 9 also shows the Event Summary in the second frame 402. This includes the number of policies the insurance carrier has issued in the Event region 405, the number of locations these policies cover 410, and the total Ground Up (“GU”) loss 415. The Ground Up Loss is the total amount of loss sustained by an insurer before deductions are applied for reinsurance and any applicable deductible. Also, the Event Summary reports the Ground Up Loss by insurance carrier division (420, 425, 430, and 435). The user can also access the Summary Report 440, the Detail Report 445, and the Query Tool 450 of this embodiment.

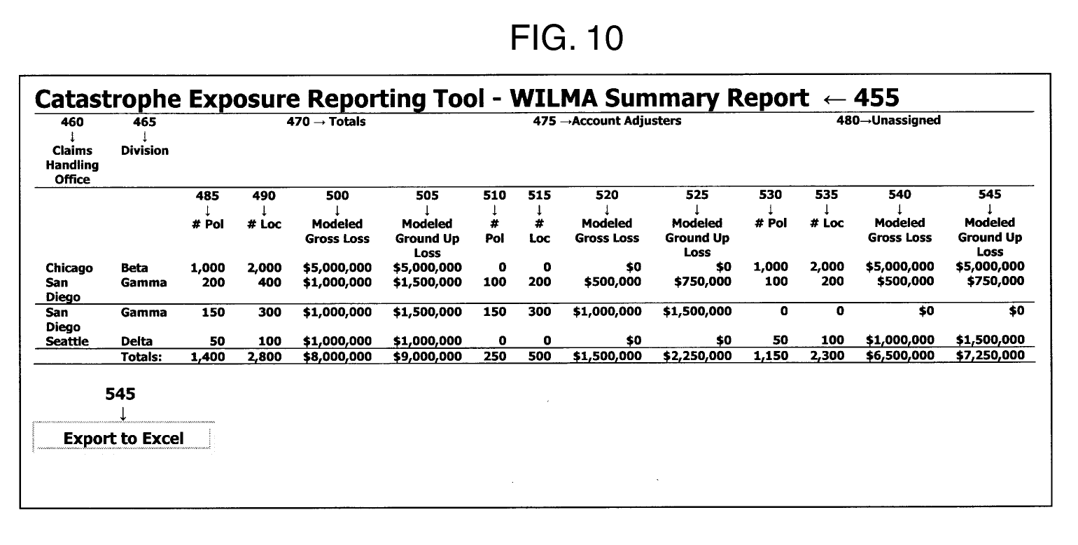

FIG. 10 illustrates an embodiment of the Summary Report. The Summary report can group information by the insurance carrier's claims office 460, division 465, and assigned and unassigned to outside independent adjusting firms (475, 480). There are three main columns of data contained in the illustrative Summary Report: “Total” 470, “Account Adjusters” 475, and “Unassigned” 480. The “Total” column shows in its sub-columns: all the polices in the event 485, the number of locations those policies cover 490, the Modeled Gross Loss for those policies within the event 500, and the Modeled Ground Up Loss 505. The “Account Adjusters” column 475 displays similar information contained in the “Total” column (510, 515, 520, and 525) but only for those policies assigned to an outside independent adjuster. Conversely, the “Unassigned” column 480, displays information for unassigned polices within the Event (530, 535, 540, 545). Finally, the user can select the push button at the bottom of the page 545 to export the data contained on this page to an Excel file.

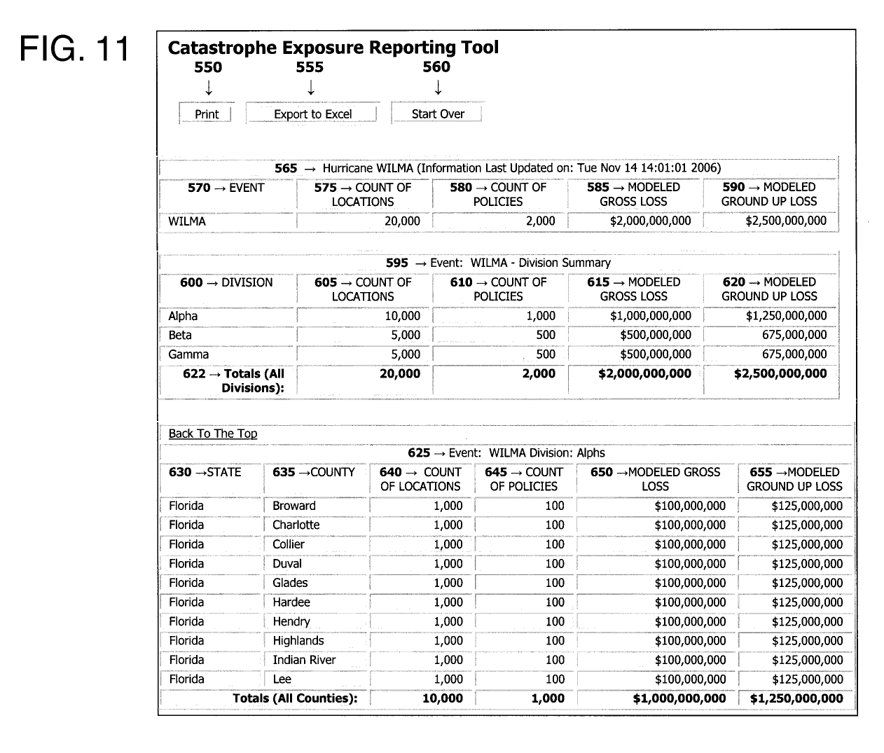

FIG. 11 presents Detail List information by Policy, Location, and Modeled Loss Totals. This information is available by Division, County, and Adjusting Firm. The first table 565 displays the name of the event 570, the number of locations affected by the event 575, the number of policies within the event 580, the overall Modeled Gross Loss of the event 585, and the overall Modeled Ground Up Loss of the Event 590. The next table 595 provides Division Summary information for the event. The first column 600 displays the name of the division within the insurance carrier that is affected by the event. The second column 605 indicates the number of locations within the event that are handled by the division. The third column 610 indicates the number of policies that are handled by the division. Furthermore, fourth 615 and fifth 620 columns show the Modeled Gross Loss and Modeled Ground Up Loss, respectively, for all the policies affected in the division by the event. Finally, the last row of the table 622 shows the total for all division with respect to all the columns. The next table 625 shows county information with respect to a division. The first column 630 indicates the state of the county. The second column 635 lists the name of the county. The third 640 and fourth 645 columns provide the number of locations, and the number of policies, respectively, within the county that affects the division. The fifth 650 and sixth 655 columns indicate the Modeled Gross Loss, and Modeled Ground Up Loss, respectively for each county within the division. Finally, the user has the three choices to manipulate the data from the illustrative Detail List Report. First, using the Print button 550, she can print out the report. Second, the user can export the report to Excel by selecting the corresponding push button 555. Finally, the user can select to start over and produce a different report 560.

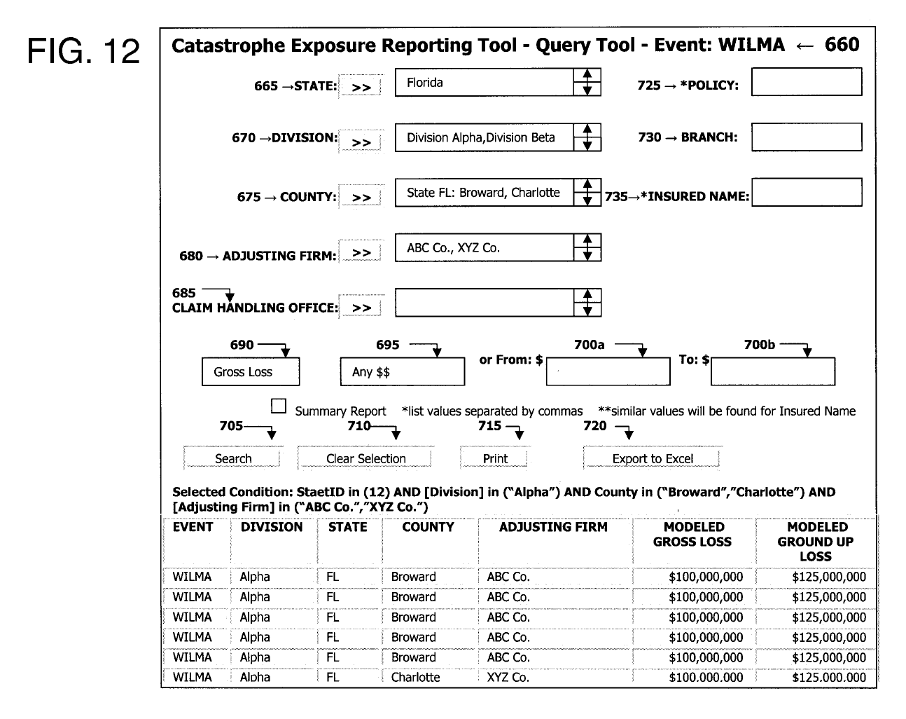

FIG. 12 is the Query Tool of the web application embodiment implementing the present invention. The Query Tool portion of the method allows the user to produce dynamic summary and detail reports for the selected event. Filtering search criteria parameters are available from the look up options: State 665, Division 670, County 675, Adjusting Firm 680, and Claim Handling Office 685. Searching by both Gross Loss and Ground Up Loss are available by using a pull down menu 690. The loss can be searched from pre-defined values from a pull down menu 695, or by typing in a range in dialog boxes in the middle of the page (700a, 700b). The user can also search by policy number. Once all the search criteria are entered, the user can run the search by selecting the “Search” push button 705. If the user would like to clear the selection to enter another search, she can select the “Clear Selection” push button 710. The user can print the data from the query tool 715 or export it to an Excel file 720.

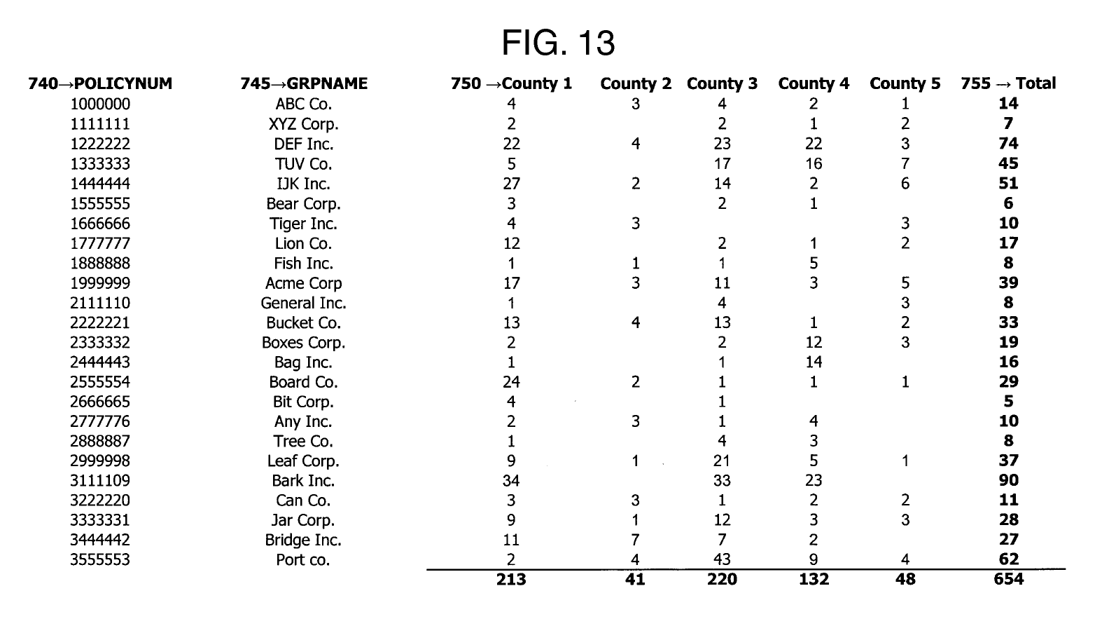

FIG. 13 is an Excel Summary Report. This report shows the affect of the event on the insurance company's policyholders. The first column 740 lists the policy number for each policyholder in the report. The second column 745 lists the group name of the policyholder. The next set of columns 750 lists the number of locations within each county affected by the Event. Finally, the last column 755 adds the number of locations affected by the Event across every county for each policyholder.

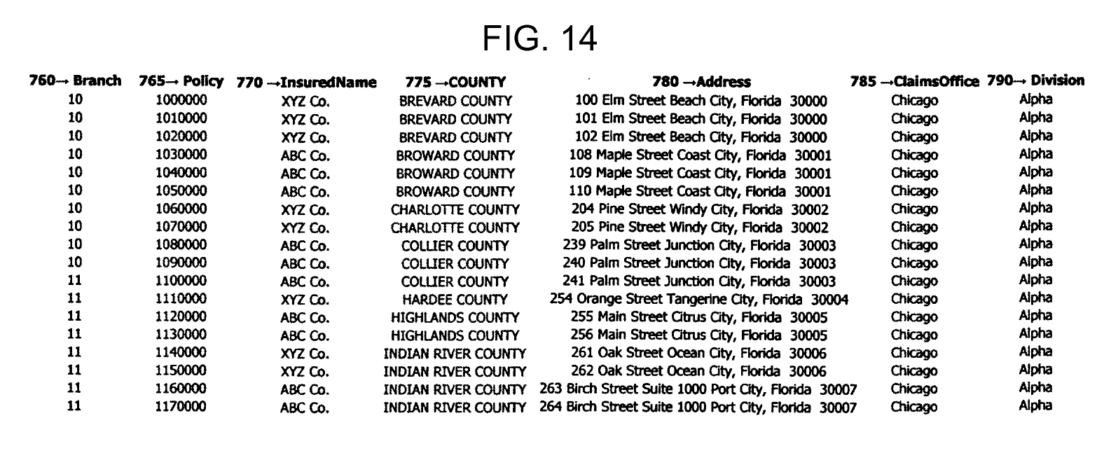

FIG. 14 is an Excel Detail Report. This report shows a detailed list of affected locations for each policyholder affected by the event. The first column 760 lists the Branch office of the insurance company. The second column 765 lists the Policy Number. Next, the third column of the report lists the Insured's Name 770. The fourth column is the county of the location affected by the Event 775. The fifth column shows the affected address of the policyholder 780. The sixth column lists the insurance company's handling office 785. Finally, in the last column, the Excel Report lists the insurance company's division that is handling the policy 790.

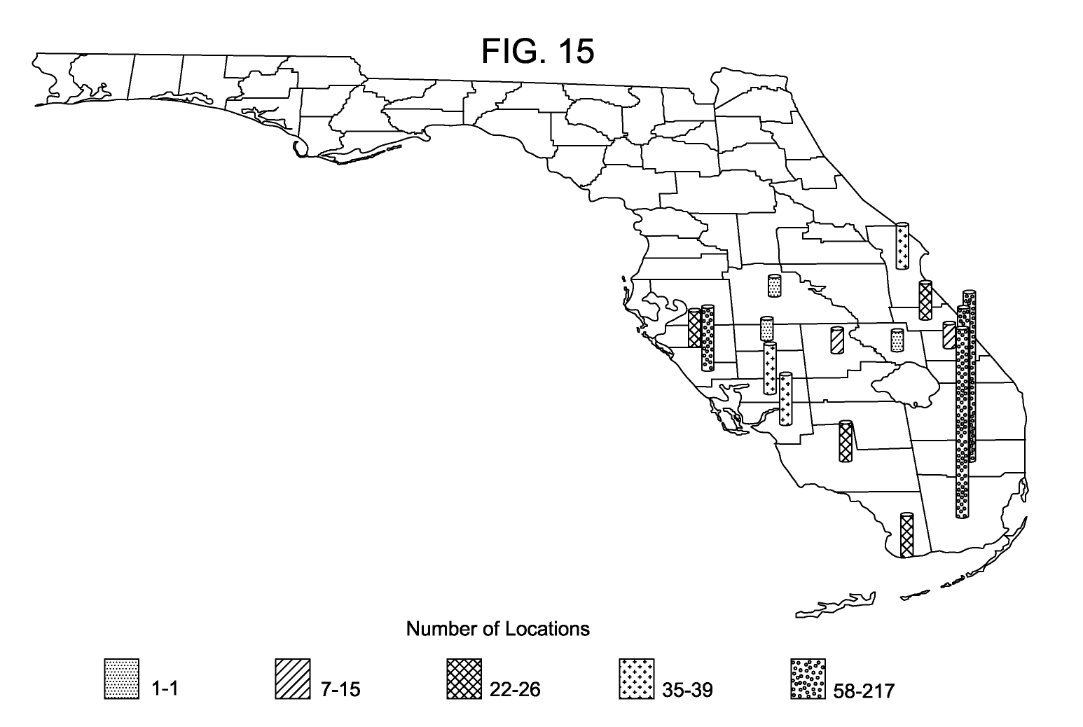

FIG. 15 is a plot summarizing all of the insurance carrier's account locations on a map of the projected damage area, organized by counties. In this embodiment, the system generates this plot using data from the modeled event. The plot can include a legend to indicate a series of number range of locations represented by a distinct indicator such as a distinctly-colored bar or a unique hatch-patterned bar, for example. This plot can allow the user to understand the density of locations affected by the event. The user can then effectively allocate and hire outside independent adjusters to assess the damage of the locations.

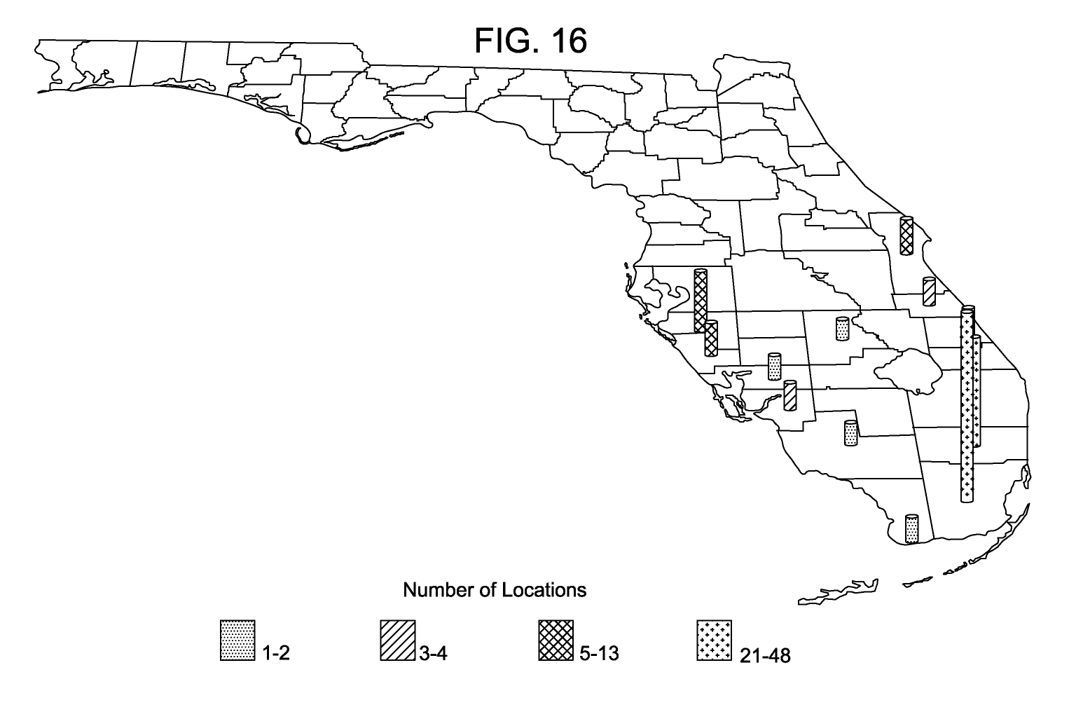

FIG. 16 is a plot of one policyholder's locations on a map of the projected damage area organized by county. The present invention in this embodiment also generates this plot using data from the modeled event. The plot divides the map into counties. It then indicates the number of locations affected by the event in each county using different-colored cylinders or different-patterned cylinders, for example. The legend below the map indicates to the user the number range of locations represented by each distinct indicator. This plot can provide information concerning one policyholder's locations affected by the Event. The user can then effectively allocate and hire outside independent adjusters to assess the damage of the locations.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for reporting catastrophe exposure of an insurance company having a plurality of policyholders caused by an event comprising the steps of:
selecting a loss event to be assessed;
modeling the event using a computer to create a projected damage area;
identifying locations of policyholders of the insurance company located in the projected damage area; and
reporting information about the policyholders in the projected damage area.

2. The method according to claim 1, wherein the event is modeled by selecting a previously-occurring event from a database of modeled previously-occurring events that is most closely similar to the loss event.

3. The method according to claim 1, further comprising:
projecting the number of claims the policyholders of the insurance company located in the projected damage area will file as a result of the event;
generating an estimate of independent adjusters necessary to process the projected claims from the policyholders of the insurance company located in the projected damage area.

4. The method according to claim 1, wherein the information reported includes a map of the projected damage area indicating the locations of policyholders of the insurance company located in the projected damage area.

5. The method according to claim 1, wherein the information reported includes exporting a summary report with a spreadsheet, text, or graphics file.

6. A system for reporting catastrophe exposure of an insurance company having a plurality of policyholders caused by an event comprising:
a modeling tool for modeling the event to create a projected damage area;
a data-processing tool for identifying policyholders of the insurance company located in the projected damage area;
a data-reporting tool for generating information concerning the policyholders of the insurance company located in the projected damage area; and
a user interface for operating the system.

7. The system according to claim 6, wherein the data-processing tool compares the locations of the identified policyholders in the damage area and the locations of a set of independent adjusters and produces a sub-listing of independent adjustors based on at least one of the location of the independent adjustor relative to the locations of the identified policyholders, the previous work experience of the independent adjustors, and the preferences of the identified policyholders.

8. The system according to claim 6, wherein the user interface has a login feature.

9. The system according to claim 6, wherein the information generated by the data-reporting tool includes a map of the projected damage area that includes information concerning at least one of the following: the number of policies, locations, and divisions within the projected damage area, the total amount of loss, and the loss for each division.
